(19) United States
(12) Patent Application Publication
(10) Pub. No.: US 2015/0122656 A1
(43) Pub. Date: May 7, 2015

(54) MASS BASED FILTRATION DEVICES AND METHOD OF FABRICATION USING BURSTS OF ULTRAFAST LASER PULSES

(71) Applicant: ROFIN-SINAR TECHNOLOGIES INC., PLYMOUTH, MI (US)

(72) Inventor: S. ABBAS HOSSEINI, ORLANDO, FL (US)

(73) Assignee: ROFIN-SINAR TECHNOLOGIES INC., PLYMOUTH, MI (US)

(21) Appl. No.: 14/531,761

(22) Filed: Nov. 3, 2014

Related U.S. Application Data
(60) Provisional application No. 61/899,718, filed on Nov. 4, 2013.

(51) Int. Cl. G01N 27/447

(52) U.S. Cl. CPC G01N 27/44756; G01N 27/44721
USPC 204/605

(57) ABSTRACT

A mass separation device includes a transparent substrate and a plurality of small diameter cylindrically shaped orifices in the transparent substrate. The small diameter cylindrically shaped orifices include smooth wall surfaces and are not tapered. The small diameter cylindrically shaped orifices are drilled by photoacoustic compression and are clean and sharp and do not have ejecta mounds surrounding the orifice on the surface of the transparent substrate. The small diameter cylindrically shaped orifices in said transparent substrate are less than or equal to 1 μm in diameter. The transparent substrate is glass and preferably is borosilicate glass.

This patent application claims priority to and the benefit of U.S. provisional patent application Ser. No. 61/899,718 filed Nov. 4, 2013. U.S. provisional patent application Ser. No. 61/899,718 filed Nov. 4, 2013 is incorporated herein in its entirety by reference hereto.

### BACKGROUND OF THE INVENTION

The present invention relates to a disposable device that filters or separates materials based on size exclusion. It provides a cheap alternative to the current mass separation devices and techniques.

Currently, one way of separating the molecular constituents of liquids and gasses is by membrane diffusion wherein the lighter atoms (or the molecules containing them) travel more quickly and are more likely to diffuse there through. The difference in speeds is proportional to the square root of the mass ratio, so the amount of separation is small and many cascaded stages are needed to obtain high purity. This method is expensive due to the work needed to push gas through a membrane and the many stages necessary.

Another separation method is centrifugal separation wherein the target material is fed into a container (generally a cylinder) that is rotated at high speed. Near the outer edge of the cylinder heavier molecules collect, while lighter molecules concentrate at the center. The lighter materials can then be fed through further cascading stages.

Electromagnetic separation uses the fact that charged particles are deflected in a magnetic field with the amount of deflection depending on the particle's mass. It is very expensive for the quantity produced, as it has an extremely low throughput, but it can allow very high purities to be achieved.

Bases are units of DNA. There are 4 bases: adenine (A), guanine (G), thymine (T), and cytosine (C), and the sequence of the bases comprise the genetic code. DNA is the fundamental unit of human genetic material. A molecule of DNA includes a sugar group, a phosphate group and a base.

One example of mass separation can be found in the well known standard DNA splicing and sequencing techniques. DNA molecules consist of four amino acids (bases) that are bounded in a form of a twisted ladder. In one leg of the DNA ladder contains different combinations of 4 amino acids (bases) of Adenine (A), Cytosine (C), Guanine (G) and Thymine (T). Combinations of the above four molecules of amino acids (bases) make the DNA codes that dictate the type of biological creature and all heritage information. Any combination in one leg of the ladder comes with a complement structure in another leg. A always connects to T and C always connects to G. As an example suppose the combination is AATCCCTGA in one leg of the ladder, the other leg will have TTAGGGACT. It is apparent that A-T and C-G are correlated.

Gene sequencing determines combinations of the amino acids (bases) and studies the effect of changing each of them. To do this, a few techniques have been developed such as:

1. Using isotope and X ray to detect the chain (oldest method, very slow) first long DNA molecule is cut to smaller size, then using heat they break the bonds so they get linear molecule out of helical molecule. For example, they have AATCCCTGA but they don't know the sequence yet. The sequence is reproduced by copy, then divided in four different containers. In one container that is going to represent A, a molecule that has A* (isotope assigned) and many A, T, C, G is added. T starts to connect to A, C starts to connect to G and reverse to make the complement leg. So the new reproduced sequence will look like this, TTAGGGACT (complement of original sequence), if A* is combined then the chain will stop and no more sequence will develop. Therefore the other two possible combinations for above chain would be: TTA* and TTAGGGA*. In another container T*, G* and C* are added respectively. For example in T* container sequences would be: T*, TT* and TTAGGGACT*. The four containers are poured in a gel container in 4 locations and high voltage is applied to initiate the electrophoresis process. Smaller molecules (lighter molecules) move faster than heavy molecules. After some time has passed, X rays are used to develop the location of molecules. By looking at the locations and comparing them in four columns, the exact locations of A, T, C, G are detected.

2. Due to difficulty in using isotopes, modern techniques use a colorful dye to detect the location of * acid. Four (4) solutions are prepared, but this time there is no isotope, same molecules are marked with a chemical sensitive to laser light (ion Ar laser) that emits four (4) different florescence if it is excited (based on dye type).

A long tube (about 40 cm long, 20 um hollow fiber) is used in presence of very high voltage to apply an electrophoresis force that pushes the molecules to move inside the tube. In one location they shine a laser and look to the emission spectrum. Main issue in this technique is the huge diameter of the fiber. It is impossible to make hollow fibers with very small diameters.

The article “Lab Chip, 2012, 12, 4455-4464”, Royal Society of Chemistry, 2012 provides further information in regard to the related art.

There are numerous other methods of particle separation such as cryogenic distillation (gravity), chemical methods based on reaction rates, and laser excitation. The one thing that all these methods have in common is that they are expensive, time consuming, and have to be performed by highly trained personnel. Another major issue is the smallest possible size that can be filtered.

Henceforth, a new method of fabricating an inexpensive mass based filtration device is disclosed. This new invention utilizes and combines new technologies of fabrication in a unique and novel configuration to construct mass separation devices that overcome the aforementioned problems.

### SUMMARY OF THE INVENTION

The general purpose of the present invention, which will be described subsequently in greater detail, is to provide a transparent substrate with a series or array of discrete, identically sized orifices formed therein, that will restrict the passage of particles therethrough based on their mass and/or diameter. It utilizes new techniques involving orifice drilling with bursts of ultrafast laser pulses that greatly simplifies the fabrication of these mass separators and reduces their cost, down to the level of a single use item.

This is accomplished by drilling orifices (round or non-round) in a glass target (or other transparent material) by using a material machining technique involving filamentation by bursts of ultrafast laser pulses with specific adjustments of the laser parameters in conjunction with a distributed focus lens assembly that creates a plurality of different foci wherein the principal focal waist never resides in or on the surface of the target, so as to create a filament in the target that develops an orifice in any or each member of a stacked array of targets wherein the orifice has a very precise width which remains constant throughout its depth, as well as extremely smooth sidewalls.

This method of orifice drilling allows for machining operational voids in any target (or in a series of stacked targets simultaneously). This technique creates micrometer and sub-micrometer scale sized orifices through transparent target materials such as borosilicate glass and other glasses.

The filter of the instant invention has multiple purposes. It discriminates based on the diameter of the mixture when it is used as filter, but when it is used as filter with a mixture that has variety of components (such as DNA samples), then position/location is determined based on how far the molecule extends into the cylinder/bore of the filter using the electrophoresis process.

State of the art small diameter holes confined in a long channel that can be produced in a well controlled array structure is not anticipated, rendered obvious, suggested, or even implied by any of the prior art, either alone or in any combination thereof. Specifically, it offers huge advances over the prior art in that these devices can be made much cheaper. All of the orifice diameters in the array that determine the actual mass/size of the particles to be separated can be precisely sized by manipulations of the laser beam laser machining system.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a diagrammatic representation of a prior art ablative laser machining arrangement wherein the principal focus occurs at the top surface of the transparent substrate;

FIG. 2 is a representative side view of an orifice ablatively machined as the laser arrangement of FIG. 1 wherein the primary focus occurs at the top surface of the transparent substrate.

FIG. 3 is a diagrammatic representation of the laser machining arrangement of the present invention wherein the primary focus occurs above the top surface of the transparent substrate;

FIG. 4 is a representative side view of two orifices drilled by the laser arrangement of FIG. 3;

FIG. 5 is a diagrammatic view of the present invention utilizing a distributed focus lens arrangement;

FIG. 6 is a diagrammatic view of the present invention utilizing a distributed focus lens arrangement and the distribution of focal waists where the principal focus is above the target;

FIG. 6A is a diagrammatic view of the present invention utilizing a distributed focus lens arrangement and the distribution of focal waists where the principal focus is below the target;

FIG. 6B is a diagrammatic view of the present invention of FIG. 6 wherein the orifice has been drilled;

FIGS. 7-9 show three various configurations of the distribution of laser energy;

FIG. 10 is a perspective view of a transparent planar substrate that has an array of laser drilled orifices therethrough so as to form a mass separator;

FIG. 11 is a top view of the mass separator of FIG. 10;

FIG. 12 is a schematic view of a consumable glass filter; and,

FIG. 13 is a schematic view of a hand held DNA Sequencer which holds the consumable glass filters and the four types of DNA samples.

### DESCRIPTION OF THE INVENTION

Various embodiments and aspects of the disclosure will be described with reference to the drawings. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

The main objective of the present invention is to provide an extremely efficient, mass or size selective particle separator and method of fabrication. Such a separation device has never been constructed before at the level of precision, and down to the level of minute particle sizes selection/filtration as the present invention offers. This is able to be accomplished because of the precise, and economical non-ablative laser machining to drill orifices in transparent materials by filamentation by a burst(s) of ultrafast laser pulses.

The Size/Mass Separation Device

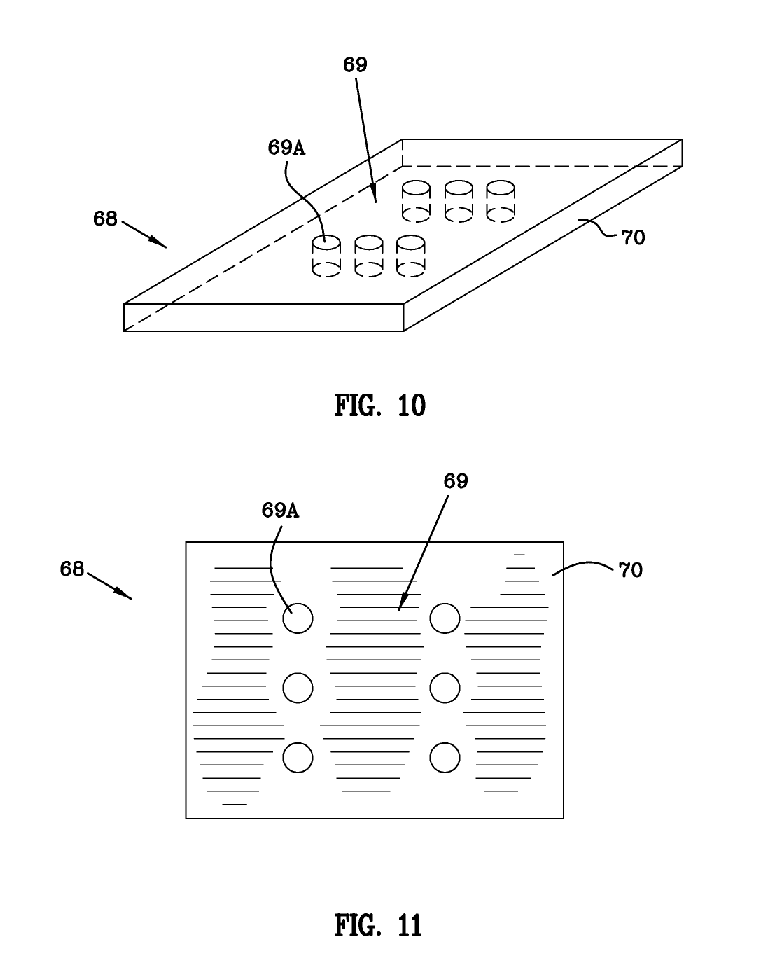

FIG. 10 is a perspective view of a transparent planar substrate that has an array of laser drilled orifices therethrough so as to form a mass separator. FIG. 11 is a top view of the mass separator of FIG. 10. The mass separation device 68 is simply a generally planar glass substrate 70 with an array of identically sized orifices 69A (holes) drilled therethrough as illustrated in FIG. 10. In operation, the material to be separated (whether gas, fluid or solid particles) is brought in contact with the planar face of the substrate 70 as a stream, such that the material passes over the orifice array 69 with a force sufficient to pass particles through the orifices in the substrate and beyond the bottom face of the device 68. In theory, a force that is perpendicular to the plane of the device works the fastest although any angle of the stream will work to a degree. The size of the orifices drilled in the substrate will be dictated by the geometric specifics of the item being separated.

The mass or size separation device is a filter, however its novelty lies in the small achievable diameters of the orifices (in the 1 μm range), the smoothness of the interior walls of the orifice, the non tapering feature of the orifice from the top to bottom face of the substrate and the lack of an ejecta mound formation. Such characteristics are only achievable by the photoacoustic compression method of laser drilling described herein. An additional benefit of the fabrication of the filter is that microcracks in the substrate are nonexistent. Microcracks weaken substrates. The orifices themselves are drilled to the desired diameter with the equipment and by the process described herein.

For molecular separation, the array of selectively sized, constant diameter holes (orifices) 69 provide size exclusion separation by selecting shorter segment molecules and not longer segment molecules. Longer segment molecules are more difficult to squeeze down into a specific hole. With the methodology and equipment described below it is possible to drill large aspect ratio orifices (3000:1) and create 3 mm long holes only 1 um in diameter at a very high rate of speed (up to 10,000 holes per sec.) Custom arrays can be created based on the expected or desired separation ratio (how fast the segments separate) which enables use of lab on chip detection arrangements against a control to determine the length of the segment. Thus, such a device enables a handheld DNA sequencing unit.

An example of use would be to separate blood components from serum in order to use lab on chip analyzers for blood chemistry. The device could be used as a disposable size exclusion filter media for use in many medical applications.

It is to be noted that while the device would appear to be a diameter separation device, it also functions as a mass separation device since the bigger (larger) molecules move slower than lighter molecules through the orifice array 69.

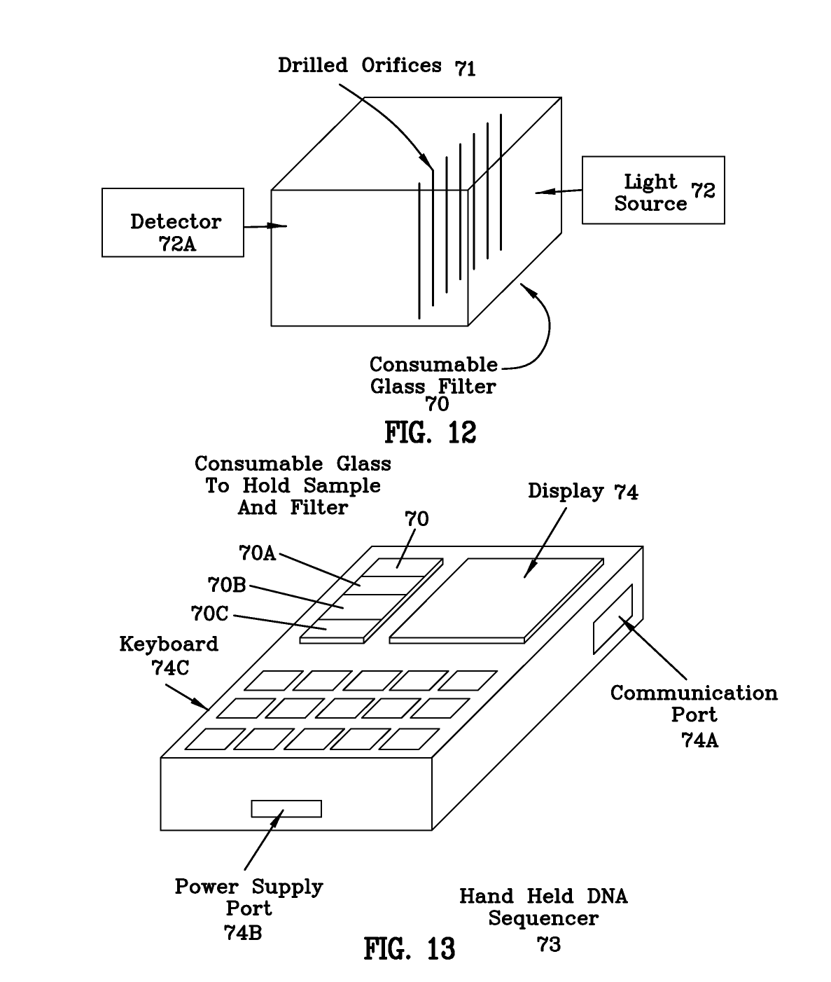

FIG. 12 is a schematic view of a consumable glass filter 70 having a plurality of orifices 71 therethrough. Light source 72 (for instance, a laser) illuminates the orifices 71 and the material which has been filtered and admitted into the orifices 71. Detector 72A determines the presence of the amino acids admitted into the orifices 71. FIG. 12 represents schematically the chip (consumable glass filter) for DNA sequencing. Capillary electrophoresis is employed which is responsible for admittance of specific molecules of the amino acid of interest, namely, A, T, C, or G into the specifically sized orifice 71. A dye is used which attaches to the amino acid of interest. An electric filed is applied across the substrate and the samples to conduct electrophoresis. The orifices of each segment are sized for admission of the molecule of interest. Laser light 72 excites the dye in the orifice channel 71 and detector 72A senses and records the spectrum thus identifying the location of the amino acid of interest. Processing of the spectrum of the filter yields the DNA sequence information and the location of the amino acid of interest.

FIG. 13 is a schematic view of a hand held DNA Sequencer 73 which holds the chip comprised of consumable glass filters 70, 70A, 70B, 70C. The four types of DNA amino acid samples, A, T, C, and G, have been dyed appropriately and the laser source 72 and detector 72A are embedded within the hand held device. Each consumable glass filter 70, 70A, 70B, 70C includes orifices sized for admittance of molecules for a particular one of the amino acid samples, A, T, C and G. Capillary electrophoresis is employed which is responsible for admittance of specific molecules of the amino acids of interest, namely, A, T, C, or G into the specifically sized orifices of each consumable glass filter 70, 70A, 70B and 70C. A dye is used for each segment which attaches to the amino acid of interest. An electric filed is applied across the each segment of the substrate and the samples to conduct electrophoresis. The orifices of each segment are sized for admission of the molecules of interest. Laser light excites the dye in the respective orifice channel and a detector 72A senses and records the spectrum. Processing of the spectrum of each segment filter yields the DNA sequence information and the location of the amino acid of interest.

A display 74, communication port 74A, power supply port 74B and keyboard 74C are used in the hand held DNA Sequencer 73 as illustrated in FIG. 13.

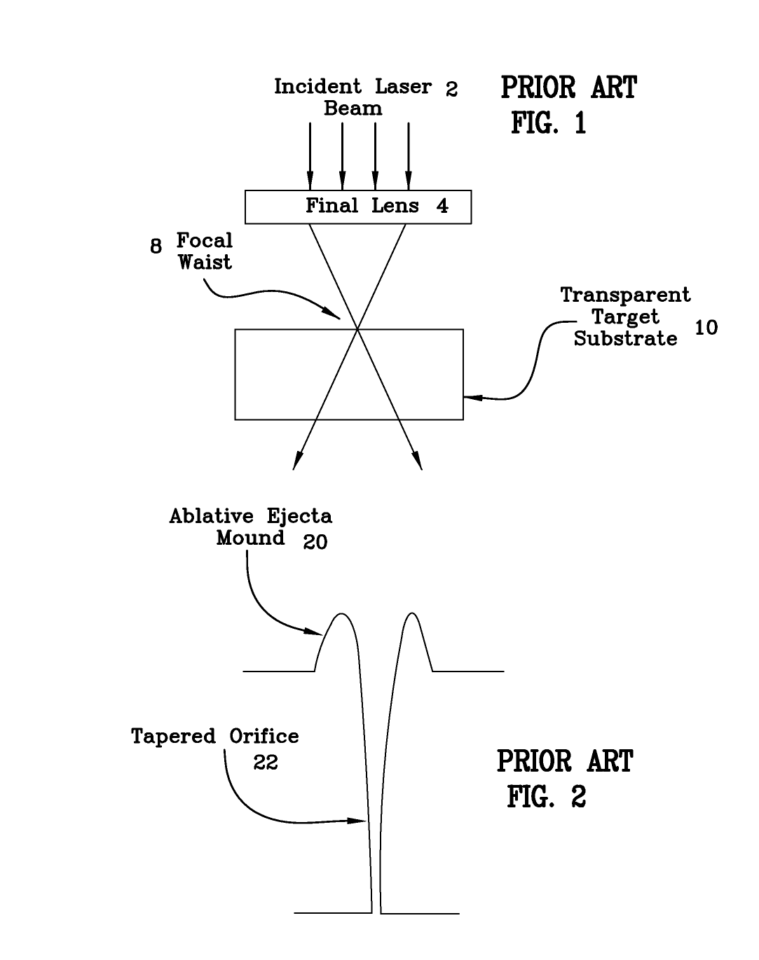

FIG. 1 is a diagrammatic representation of a prior art ablative laser machining arrangement wherein the principal focus occurs at the top surface of the transparent substrate. Generally, in the prior art, laser ablation techniques that utilize a high energy pulsed laser beam that is focused to a single principal focus above, within or at a surface of the material, have been used to machine and drill holes. Mainly there are two methods of percussion and helical drilling. Holes of 20 μm and deeper up to 300 μm deep or longer can be drilled. Generally there would be a taper on the top surface with a lot of debris as a consequence.

Propagation of intense ultrafast laser pulses in different optical media has been well studied. Nonlinear refractive index of a material is a function of laser intensity. Having an intense laser pulse with Gaussian profile, wherein the central part of the pulse has much higher intensity than the tails, means the refractive index varies for the central and surrounding areas of the material seeing the laser beam pulse. As a result, during propagation of such laser pulse, the pulse collapses automatically. This nonlinear phenomenon is known in the industry as self-focusing. Self-focusing can be promoted also using a lens in the beam path. In the focal region the laser beam intensity reaches a value that is sufficient to cause multiple-ionization, tunnel ionization and avalanche ionization, which creates plasma in the material. Plasma causes the laser beam to defocus but due to high peak intensity laser pulse refocus back to form the next plasma volume. The balancing act between focusing and defocusing creates a long chain of plasma channel known as filament. The inherent problem with a sharp and tight focus is that the beam diverges right after creation of first plasma volume which is known as optical break down. This is the obvious drawback for using the prior art laser drilling methods as they limit the size and length of the orifice that can be drilled, cause a rough orifice wall and result in an orifice with a taper 22 having a different diameter at the top and bottom surfaces of the target 10. See FIG. 2. This occurs because in ablative machining, the beam has central focus (also referred to as a principal focal waist) at the surface of the target 10 causing localized heating and thermal expansion therein heating the surface of the material 10 to its boiling point and generating a keyhole. The keyhole leads to a sudden increase in optical absorptivity quickly deepening the orifice. As the orifice deepens and the material boils, vapor generated erodes the molten walls blowing ejecta 20 out and further enlarging the orifice 22. As this occurs, the ablated material applies a pulse of high pressure to the surface underneath it as it expands. The effect is similar to hitting the surface with a hammer and brittle materials are easily cracked. Additionally, brittle materials are particularly sensitive to thermal fracture which is a feature exploited in thermal stress cracking but not desired in orifice drilling. OB generally is reached when the debris is not ejected, a bubble is created in the orifice 22 or there is a violent ablation that cracks the target in the area of the orifice 22. Any one or combination of these effects causes the laser beam to scatter from this point or be fully absorbed not leaving enough beam power (fluence) to drill down through the material 10 any further. Additionally, this creates a distortion or roughness known as the ablative ejecta mound 20 found around the initiating point at the surface of the target substrate 10. See FIG. 2 which is a representative side view of an orifice ablatively machined as the laser arrangement of FIG. 1 wherein the primary focus occurs at the top surface of the transparent substrate.

The present invention solves the optical breakdown problem, minimizes the orifice roughness and the ablative ejecta mound, and eliminates the tapering diameter orifice.

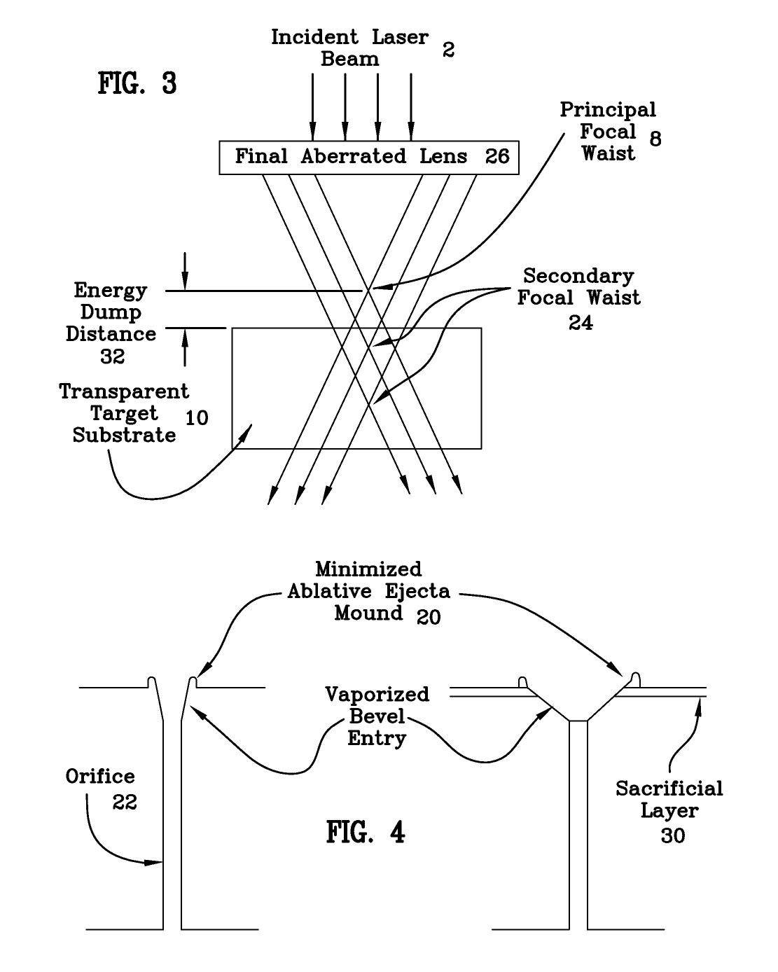

FIG. 3 is a diagrammatic representation of the laser machining arrangement of the present invention wherein the primary focus occurs above the top surface of the transparent substrate. Referring to FIG. 3 and others, the present disclosure provides devices, systems and methods for the processing of orifices in transparent materials by laser induced photoacoustic compression. Unlike previously known methods of laser material machining, embodiments of the present invention utilize an optical configuration that focuses the incident beam 2 in a distributed manner along the longitudinal beam axis such that there is a linear alignment of the principal focus 8 and secondary foci 24 (coincident to the linear axis of the orifice but vertically displaced from the principal focus or focal waist) to allow the continual refocusing of the incident beam 2 as it travels through the material 10 thereby enabling the creation of a filament that modifies the index of refraction along the beam path in the material 10 and does not encounter optical breakdown (as seen in the prior art ablative drilling systems both with and without the use of rudimentary filamentation) such that continued refocusing of the laser beam in the target material can continue over long distances.

Still referring to FIG. 3, the distributed focusing method allows for the “dumping” or reduction of unnecessary energy from the incident beam 2 found at the principal focal waist 8 by the creation of secondary foci 24 by the distributed focusing elements assembly 26, and by positioning the location of the principal focal waist 8 from on or in the material, to outside the material 10. This dumping of beam fluence combined with the linear alignment of the principal focal waist 8 and secondary focal waists 24, enables the formation of filaments while maintaining sufficient laser intensity (fluence μJ/cm²) to accomplish actual modification and compression over the entire length of the filament zone. This distributed focusing method supports the

formation of filaments with lengths well beyond one millimeter and yet maintaining an energy density beneath the optical breakdown threshold of the material with intensity enough so that even multiple stacked substrates can be drilled simultaneously across dissimilar materials (such as air or polymer gaps between layers of target material) with negligible taper over the drilled distance, and a relatively smooth walled orifice wall that can be initiated from above, below or within the target material.

The optical density of the laser pulse initiates a self focusing phenomena and generates a filament of sufficient intensity to non-ablative initial photoacoustic compression in a zone within/about/around the filament so as to create a linear symmetrical void of substantially constant diameter coincident with the filament, and also causes successive self focusing and defocusing of said laser pulse that coupled with the energy input by the secondary focal waists of the distributed beam forms a filament that directs/guides the formation of the orifice across or through the specified regions of the target material. The resultant orifice can be formed without removal of material from the target, but rather by a photoacoustic compression of the target material about the periphery of the orifice formed.

It is known that the fluence levels at the surface of the target 10 are a function of the incident beam intensity and the specific distributed focusing elements assembly, and are adjusted for the specific target material(s), target(s) thickness, desired speed of machining, total orifice depth and orifice diameter. Additionally, the depth of orifice drilled is dependant on the depth over which the laser energy is absorbed, and thus the amount of material removed by a single laser pulse, depends on the material's optical properties and the laser wavelength and pulse length. For this reason a wide range of process parameters are listed herein with each particular substrate and matching application requiring empirical determination for the optimal results with the system and materials used. As such, the entry point on the target 10 may undergo some minimal ablative ejecta mound formation 20 if the fluence levels at the surface are high enough to initiate momentary, localized ablative (vaporized) machining, although this plasma creation is not necessary. In certain circumstances it may be desirable to utilize a fluence level at the target surface that is intense enough to create the transient, momentary ablative drilling to give a broad bevelled entry yet have the remainder of the orifice 22 of uniform diameter as would be created by a distributed focus hybrid drilling method using an energy level that permits a momentary ablative technique followed by a continual photoacoustic compression technique. See FIG. 4 which is a representative side view of two orifices drilled by the laser arrangement of FIG. 3. This can be accomplished by the present invention by selection of a fluence level at the target surface that balances the linear absorption against the non linear absorption of the beam in the material such that the fluence level required for ablative machining will be exhausted at the desired depth of the bevelled (or other geometric configuration). This hybrid technique will result in a minor ejecta mound 20 that can be eliminated if a sacrificial layer 30 is applied to the target surface. Common sacrificial layers are resins or polymers such as but not limited to PVA, Methacrylate or PEG, and generally need only be in the range of 1 to 300 microns thick (although the 10-30 micron range would be utilized for transparent material machining) and are commonly applied by spraying the sacrificial layer onto the target material. The sacrificial layer will inhibit the formation of an ejecta mound on the target 10 by preventing molten debris from attaching itself to the surface, attaching instead to the removable sacrificial material as is well known in the art.

To accomplish photoacoustic compression machining requires the following system:
A burst pulse laser system capable of generating a beam comprising a programmable train of pulses containing from 1 to 50 subpulses within the burst pulse envelope. Further the laser system needs to be able to generate average power from 1 to 200 watts depending on the target material utilized, typically this range would be in the range of 50 to 100 watts for borosilicate glass.
Pulses must have duration less than 100 ps and each pulse peak power must exceeds threshold peak power of the material for filament formation, in case of borosilicate this power is above 5 MW.
A distributed focusing element assembly (potentially comprising positive and negative lenses but having a positive focusing effect in the aggregate) capable of producing a weakly convergent, multi foci spatial beam profile where the incident fluence at the target material is sufficient to cause Kerr-effect self-focusing and propagation.
An optical delivery system capable of delivering the beam to the target.

Commercial operation would also require translational capability of the material (or beam) relative to the optics (or vice versa) or coordinated/compound motion driven by a system control computer.

The use of this system to drill photoacoustic compression orifices requires the following conditions be manipulated for the specific target/s: the properties of the distributed focus element assembly; the burst pulsed laser beam characteristics; and the location of the principal focus.

The distributed focus element assembly 26 may be of a plethora of generally known focusing elements commonly employed in the art such as aspheric plates, telecentric lenses, non-telecentric lenses, aspheric lenses, annularly faceted lenses, custom ground aberrated (non-perfect) lenses, axicon lens, a combination of positive and negative lenses or a series of corrective plates (phase shift masking), any optical element tilted with respect to the incident beam, and actively compensated optical elements capable of manipulating beam propagation. The principal focal waist of a candidate optical element assembly as discussed above, generally will not contain more than 90% nor less than 50% of incident beam fluence at the principal focal waist. Although in specific instances the optical efficiency of the distributed focus element assembly 26 may approach 99%.

A sample optical efficiency for drilling a 1 micron diameter through orifice in a 2 mm thick single, planar target made of borosilicate with a 1064 nm wavelength, 50 Watt laser outputting 5 pulses in each burst with 50 μJ energy/pulse having a frequency (repetition rate) that would lie in the 200 kHz range is 65% wherein the principal focal waist of the beam resides 500 μm off of the desired point of initiation.

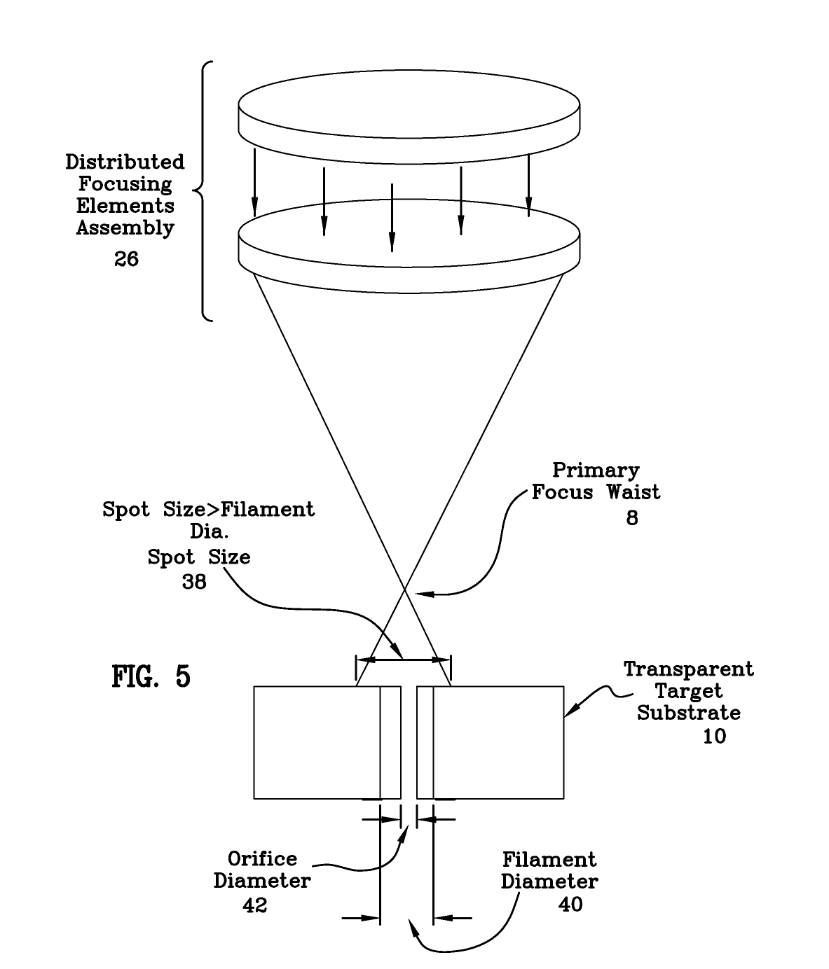

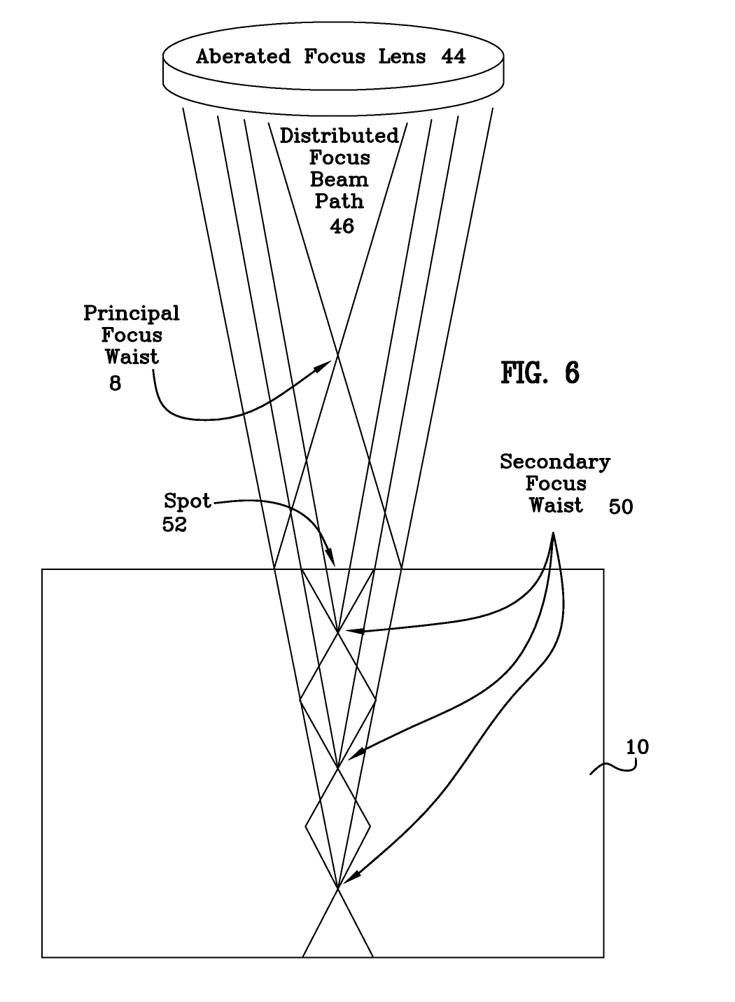

It is to be noted that there is also a set of physical parameters that must be met by this photoacoustic compression drilling process. Referring to FIG. 5 it can be seen that the beam spot diameter 38>the filament diameter 40>the orifice diameter 42. Additionally the distributed beam's primary focal waist 8 is never in or on the surface of the target material 10 into which a filament is created. FIG. 5 is a diagrammatic view of the present invention utilizing a distributed focus lens arrangement.

The location of the principal focal waist 8 is generally in the range of 500 microns to 5 mm off of the desired point of initiation. This is known as the energy dump distance 32. It also is determined by the creation an empirical table tailored for each transparent material, the physical configuration and characteristics of the target as well as the laser parameters. It is extrapolated from the table created by the method noted above.

The laser beam energy properties are as follows: a pulse energy in the beam between 10 μJ to 500 μJ, the repetition rate from 1 Hz to 2 MHz (the repetition rate defines the speed of sample movement and the spacing between neighboring filaments). The diameter and length of the filament may be adjusted by changing the temporal energy distribution present within each burst envelope.

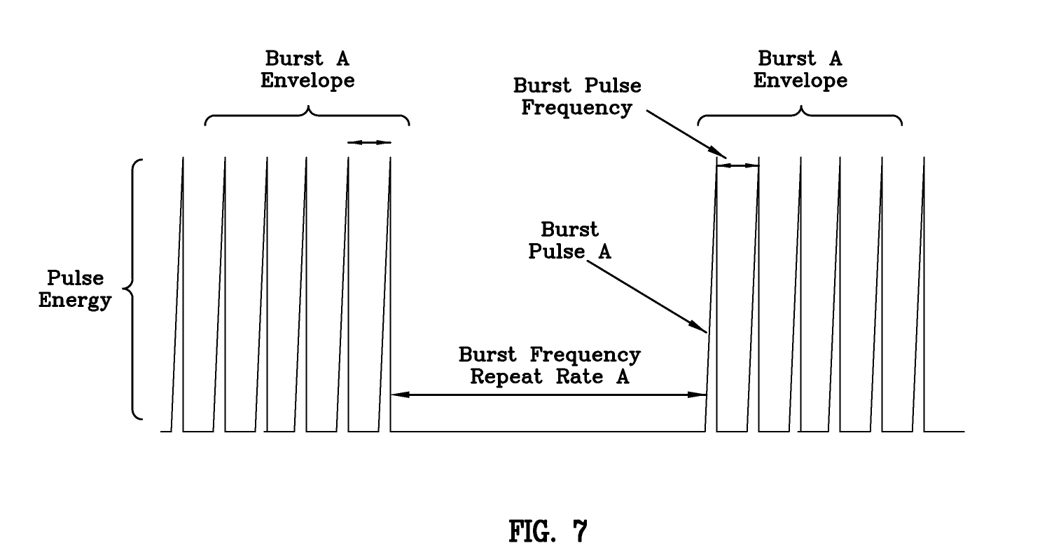

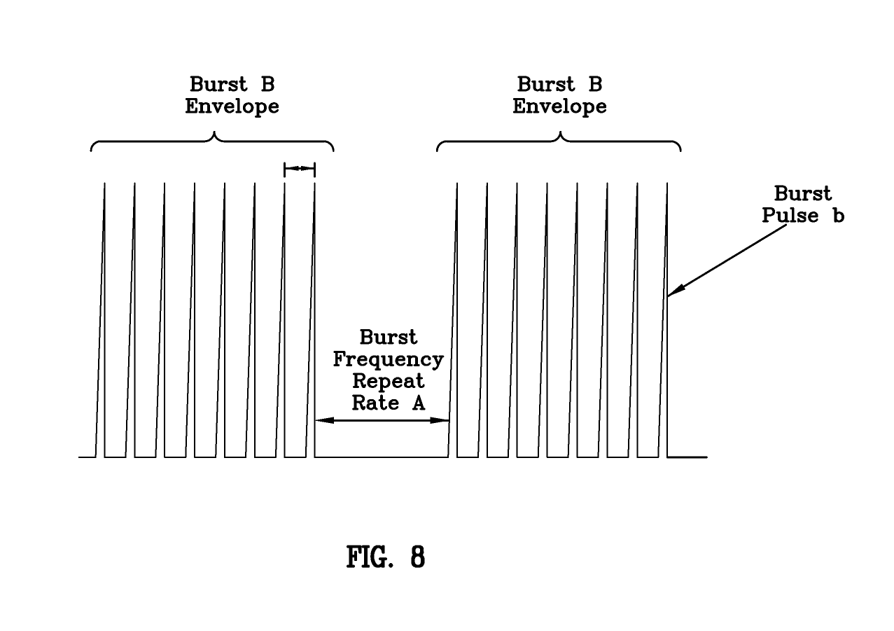

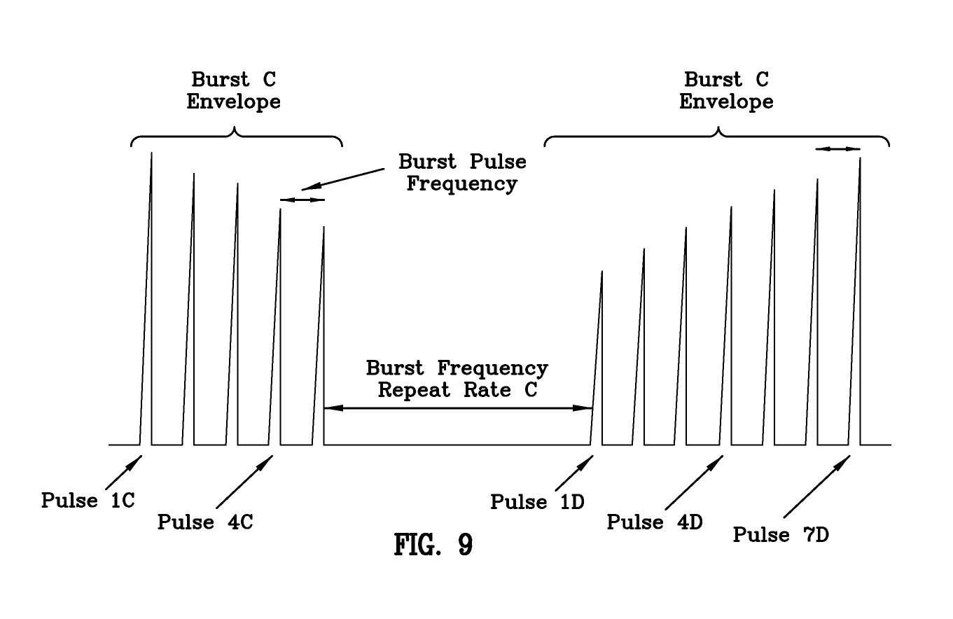

FIGS. 7-9 illustrate examples of three different temporal energy distributions of a burst pulsed laser signal. The rising and falling burst envelope profiles of FIG. 9 represent a particularly useful means of process control especially well adapted for removing thin metal layers from dielectric materials.

The mechanism of the present invention can best be illustrated. Herein, burst picosecond pulsed light is used because the total amount of energy deposited in the target material is low and photoacoustic compression can proceed without cracking the material, and less heat is generated in the target material thus efficient smaller packets of energy are deposited in the material so that the material can be raised incrementally from the ground state to a maximally excited state without compromising the integrity of the material in the vicinity of the filament.

The actual physical process occurs as described herein. The principal focal waist of the incident light beam of the pulsed burst laser is delivered via a distributed focusing element assembly to a point in space above or below (but never within) the target material in which the filament is to be created. This will create on the target surface a spot as well as white light generation. The spot diameter on the target surface will exceed the filament diameter and the desired feature (orifice, slot, etc.) diameter. The amount of energy thus incident in the spot on surface being greater than the critical energy for producing the quadratic electro-optic effect (Kerr effect—where the change in the refractive index of the material is proportional to the applied electric field) but is lower that the critical energy required to induce ablative processes and more explicitly below the optical breakdown threshold of the material. Self-focusing occurs above a critical power that satisfies the relationship whereby the power is inversely related to the product of the real and complex indices of refraction for the target material. Photoacoustic compression proceeds as a consequence of maintaining the required power in the target material over time scales such that balancing between the self-focus condition and the optical breakdown condition can be maintained. This photoacoustic compression is the result of a uniform and high power filament formation and propagation process whereby material is rearranged in favor of removal via ablative processes. The extraordinarily long filament thus produced is fomented by the presence of spatially extended secondary foci created by the distributed focusing element assembly, maintaining the self focusing effect without reaching optical breakdown. In this assembly, a large number of marginal and paraxial rays converge at different spatial locations relative to the principal focus. These secondary foci exist and extend into infinite space but are only of useful intensity over a limited range that empirically corresponds to the thickness of the target. By focusing the energy of the second foci at a lower level below the substrate surface but at the active bottom face of the filament event, allows the laser energy access to the bulk of the material while avoiding absorption by plasma and scattering by debris.

The distributed focal element assembly can be a single aberrated focal lens placed in the path of the incident laser beam to develop what appears to be an unevenly distributed focus of the incident beam into a distributed focus beam path containing a principal focal waist and a series of linearly arranged secondary focal waists (foci). The alignment of these foci is collinear with the linear axis of the orifice 42. Note that the principal focal waist 8 is never on or in the target material 10.

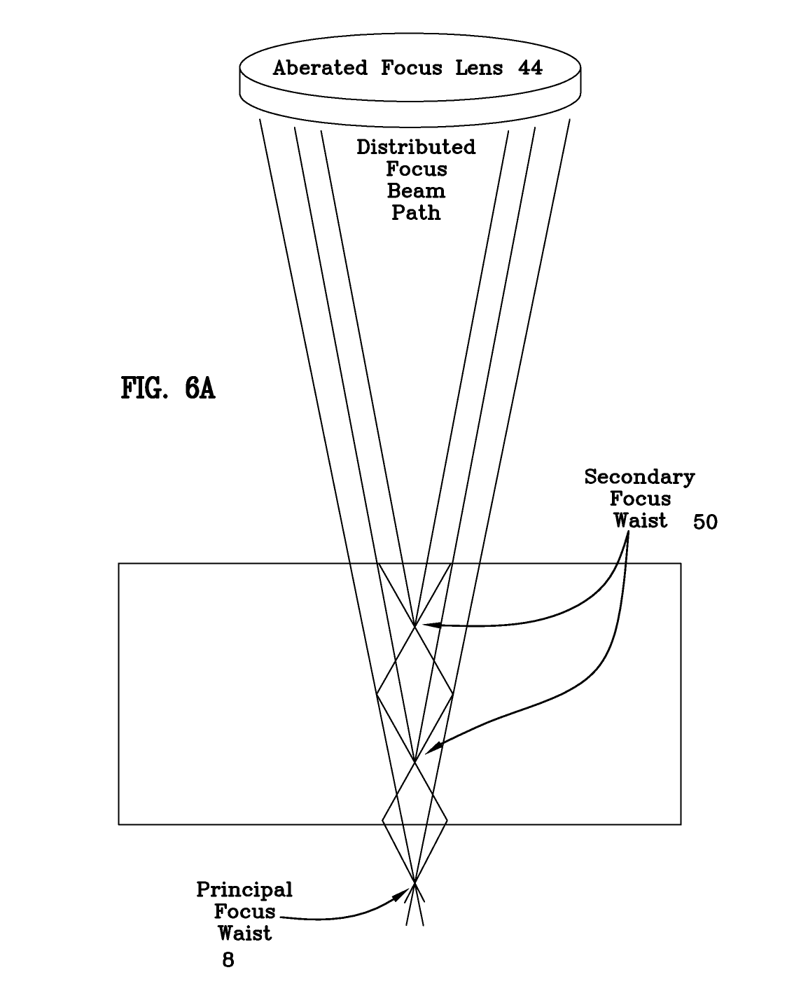

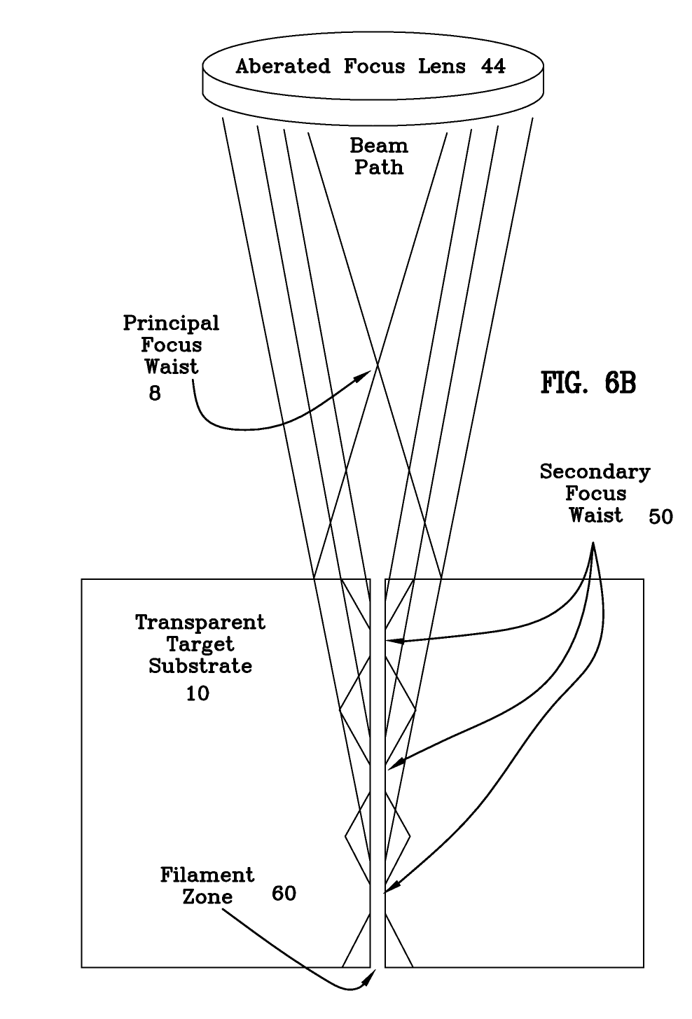

In FIG. 6 the principal focal waist is above the target material and in FIG. 6A it is below the target material 10 as the orifice 42 may be initiated above or below the principal focal waist 8 by virtue of the symmetric and non-linear properties of the focused beam. Thus a beam spot 52 (approximately 10 μm distance) resides on the surface of the target 10 and the weaker secondary focal waists collinearly reside within the target because the material acts as the final optical element creating these focal points as the electric field of the laser alters the indices of refraction of the target. This distributed focus allows the amount of laser energy to be deposited in the material so as to form a filament line or zone 60. See FIG. 6B.

FIG. 6 is a diagrammatic view of the present invention utilizing a distributed focus lens arrangement and the distribution of focal waists where the principal focus is above the target. FIG. 6A is a diagrammatic view of the present invention utilizing a distributed focus lens arrangement and the distribution of focal waists where the principal focus is below the target. FIG. 6B is a diagrammatic view of the present invention of FIG. 6 wherein the orifice has been drilled.

With multiple linear aligned foci and by allowing the material to act as the final lens, the target material when bombarded with ultrafast burst pulse laser beams, undergoes numerous, successive, localized heatings which thermally induced changes in the material's local refractive index (specifically, the complex index) along the path of the liner aligned foci causing a lengthy untapered filament 60 to be developed in the target followed by an acoustic compression wave that annularly compresses the material in the desired region creating a void and a ring of compressed material about the filamentation path. Then the beam refocuses and the refocused beam combined with the energy at the secondary focal waists maintains the critical energy level and this chain of events repeats itself so as to drill an orifice capable of 3000:1 aspect ratio (length of orifice/diameter of orifice) with little to no taper and an entrance orifice size and exit orifice size that are effectively the same diameter. This is unlike the prior art that focuses the energy on the top surface of or within the target material resulting in a short filamentation distance until the optical breakdown is reached and filamentation degrades or ceases.

The method of drilling orifices is through photoacoustic compression is accomplished by the following sequence of steps:

1. passing laser energy pulses from a laser source through a selected distributive-focus lens focusing assembly;

2. adjusting the relative distance and or angle of said distributive-focus lens focusing assembly in relation to a laser source so as to focus the laser energy pulses in a distributed focus configuration to create a principal focal waist and at least one secondary focal waist;

3. adjusting the principal focal waist or the target such that the principal focal waist will not reside on or in the target that is being machined;

4. adjusting the focus such that the spot of laser fluence on the surface of the target that is located below or above said principal focal waist, has a diameter that is always larger than a diameter of a filamentation that is formed in the target;

5. adjusting the fluence level of the secondary focal waists are of sufficient intensity and number to ensure propagation of a photoacoustic compressive machining through the desired volume of the target; and

6. applying at least one burst of laser pulses of a suitable wavelength, suitable burst pulse rep rate and suitable burst pulse energy from the laser source to the target through the selected distributive-focus lens focusing assembly, wherein the total amount of pulse energy or fluence, applied to the target at a spot where the laser pulse contacts the point of initiation of machining on the target, is greater that the critical energy level required to initiate and propagate photoacoustic compression machining, yet is lower than the threshold critical energy level required to initiate ablative machining; and

7. stopping the burst of laser pulses when the desired machining has been completed.

The following table includes parameters used in photoacoustic compression machining of orifice arrays for mass and size exclusion.

Laser Properties

| | |
|---|---|
| Wavelength | 5 microns or less |
| Pulse width | 10 nanoseconds or less |
| Freq (laser pulse | 1 Hz to 2 MHz |
| repetition rate) | |
| Average power | 200-1 watt |
| Number of sub pulses | 1 to 50 |
| per burst | |
| Sub pulse spacing | 1 nanosecond to 10 microsecond |
| Pulse energy | 5 micro Joules (μJ) to 500 micro Joules (μJ) |
| | (Average power/repetition rate) |
| | watts/1/sec |

Orifice Properties

| | |
|---|---|
| Min Orifice Diameter | .5 microns |
| Max Orifice Diameter | 50 microns |
| Max Orifice Depth | 10 mm in borosilicate glass |
| Typical Aspect Ratio | 1500:1 |
| Max Aspect Ratio | 3000:1 |
| Orifice Sidewall | <5 micron ave. roughness |
| Smoothness (Material | (e.g., Si, SiC, SiN, GaAs, GaN, InGaP) |
| Independent) | |
| Orifice Side Wall Taper | Negligible across 10,000 micron depth |
| (Material Independent) | |

Beam Properties

| | |
|---|---|
| Focal Distribution | −5 to 4,000 |
| M² | 1.00-5.00 |

1. A mass separation device, comprising:
a transparent substrate;
a plurality of small diameter cylindrically shaped orifices in said transparent substrate;
said small diameter cylindrically shaped orifices include smooth wall surfaces;
said small diameter cylindrically shaped orifices are not tapered; and, said small diameter cylindrically shaped orifices being drilled by photoacoustic compression.

2. A mass separation device as claimed in claim 1, further comprising:
said transparent substrate has a surface; and,
said small diameter cylindrically shaped orifices are clean and sharp and do not have ejecta mounds surrounding said orifice on said surface of said transparent substrate.

3. A mass separation device as claimed in claim 1, further comprising:
said small diameter cylindrically shaped orifices in said transparent substrate are less than or equal to 1 μm in diameter.

4. A mass separation device as claimed in claim 1 wherein said transparent substrate is glass.

5. A mass separation device as claimed in claim 4 wherein said transparent substrate is borosilicate glass.

6. A hand held DNA sequence device, comprising:
a transparent substrate;
said transparent substrate includes segments thereof;
each segment of said transparent substrate includes a plurality of small diameter cylindrically shaped orifices for detection of DNA bases, said small diameter cylindrically shaped orifices in each segment sized for the admission of a specific DNA molecules;
said small diameter cylindrically shaped orifices include smooth wall surfaces;
said small diameter cylindrically shaped orifices are not tapered; and, said small diameter cylindrically shaped orifices being drilled by photoacoustic compression.

7. A hand held DNA sequence device as claimed in claim 6, further comprising:
each segment of said transparent substrate has a surface; and,
said small diameter cylindrically shaped orifices are clean and sharp and do not have ejecta mounds surrounding said orifice on said surface of said transparent substrate.

8. A hand held DNA sequence device as claimed in claim 6, further comprising:
said small diameter cylindrically shaped orifices in each segment of said transparent substrate are less than or equal to 1 μm.

9. A hand held DNA sequence device as claimed in claim 6 wherein said transparent substrate is glass.

10. A hand held DNA sequence device as claimed in claim 9 wherein said transparent substrate is borosilicate glass.

11. A hand held DNA sequence device as claimed in claim 6, further comprising:
a sample containing DNA and a dye resides in each of said small diameter cylindrically shaped orifices of each of said plurality of small diameter cylindrically shaped orifices of each segment of said transparent substrate for detection of DNA bases.

12. A hand held DNA sequence device as claimed in claim 11, further comprising:
an electric field applied across said transparent substrate and said samples to conduct electrophoresis.
